(19) United States
(12) Patent Application Publication
(10) Pub. No.: US 2014/0166664 A1
(43) Pub. Date: Jun. 19, 2014

(54) Conformal Tank For Adsorbant Natural Gas Storage

(71) Applicants: Yuyi Lin, Columbia, MO (US); Hao Xu, Columbia, MO (US)

(72) Inventors: Yuyi Lin, Columbia, MO (US); Hao Xu, Columbia, MO (US)

(73) Assignee: The Curators of the University of Missouri, Columbia, MO (US)

(21) Appl. No.: 14/107,457

(22) Filed: Dec. 16, 2013

Related U.S. Application Data
(60) Provisional application No. 61/797,925, filed on Dec. 17, 2012.

(51) Int. Cl. B60K 15/03

(52) U.S. Cl. CPC B60K 15/03006
USPC 220/562

(57) ABSTRACT

The present disclosure provides a conformal tank for adsorbent storage of gas. The tank includes a body having a substantially flat top wall, a substantially flat bottom wall and a pair of opposing sidewalls that join the top wall and bottom wall to form an open-ended cuboid having a first open end and an opposing second open end. The tank additionally includes a first end cap connected to the top wall, bottom wall and sidewalls at the first open end, and a second end cap connected to the top wall, bottom wall and sidewalls at the second open end, thereby defining an internal cavity in which gas can be removably stored. The tank further includes a plurality of wall supports connected the top and bottom walls to prevent deformation of the tank. The wall supports are structured to allow gas to move throughout the entire internal cavity of the tank.

### CROSS-REFERENCE TO RELATED APPLICATIONS

This application claims the benefit of U.S. Provisional Application No. 61/797,925, filed on Dec. 17, 2012.

### FIELD

The present teachings relate to conformal tanks for adsorbent storage of gas, and more particularly to conformal absorbent natural gas tanks for use in all types of passenger vehicles, lawn equipment, gas utilizing tools, and heating devices and systems.

### BACKGROUND

The statements in this section merely provide background information related to the present disclosure and may not constitute prior art.

A conformal tank is a pressurized gas storage tank that is structured to have a shape that will fit within an available space of the system in which the tank is to be used. For example, a conformal tank can be structured to have a shape that is complementary to and will fit with a particular cavity or space within a particular passenger vehicle.

Known conformal tanks are typically multi-cylinder tanks structured by joining together a plurality of individual and independent cylindrical tanks, e.g., welding the individual tanks together and/or strapping/wrapping the individual tanks together using an exterior housing, wrapping or strapping. Additionally, the interiors of each individual tank, where the gas stored, are joined together using exterior tubing and/or piping such that each of the individual tanks can be filled with gas and the stored gas can be retrieved from each tank via a single inlet/outlet port or valve.

Known conformal tanks are typically very heavy and do not conform to the available space very well. For example, known conformal tanks typically have approximately a 0.75 conformity index, that is, the multi-cylindrical tanks typically only fill approximately 75% of the available space leaving approximately 25% of the available space unused. Additionally, known conformal tanks have been design for storage and usage of compressed natural gas are stored a pressures of approximately 3600 psi or higher, which require each individual tank be heavily constructed to withstand such high pressures. According, such conformal tanks are very heavy and add considerable, undesirable, weight to the respective vehicle or device.

### SUMMARY

The present disclosure provides a conformal tank for adsorbent storage of gas. The tank includes a body having a substantially flat top wall, a substantially flat bottom wall and a pair of opposing sidewalls that join the top wall and bottom wall to form an open-ended cuboid having a first open end and an opposing second open end. The tank additionally includes a first end cap connected to the top wall, bottom wall and sidewalls at the first open end, and a second end cap connected to the top wall, bottom wall and sidewalls at the second open end, thereby defining an internal cavity in which gas can be removably stored. The tank further includes a plurality of wall supports connected the top and bottom walls to prevent deformation of the tank. The wall supports are structured to allow gas to move throughout the entire internal cavity of the tank.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is an isometric view of a conformal tank for adsorbent storage of a gas, in accordance with various embodiment of the present disclosure.

FIG. 2 is an expanded view of the conformal tanks shown in FIG. 1, in accordance with various embodiments of the present disclosure.

FIG. 2A is cross-sectional view of the conformal tank shown in FIG. 1, in accordance with various embodiments of the present disclosure.

FIG. 3 is a section of a cross-sectional view of the conformal tank shown in FIG. 1, wherein a top side and bottom side of the conformal tank are not parallel, in accordance with various embodiments of the present disclosure.

FIG. 4 sectional view of a cross-section of a top wall of the conformal tank shown in FIG. 1 having an indentation to counter sink as force distribution washer, in accordance with various embodiments of the present disclosure.

FIG. 5 is and isometric view of the conformal tank shown in FIG. 1, in accordance various other embodiments of the present disclosure, wherein a portion of the top side has been graphically removed for illustration purposes.

FIG. 6 is a front view of a flat first end cap of the conformal tank shown in FIG. 5 having a plurality of support ridges on at least an exterior face, in accordance with various embodiments of the present disclosure.

FIG. 7 is an isometric view of the conformal tank shown in FIG. 5 having a domed first end cap and second cap.

Corresponding reference numerals indicate corresponding parts throughout the several views of drawings.

### DETAILED DESCRIPTION

The following description is merely exemplary in nature and is in no way intended to limit the present teachings, application, or uses. Throughout this specification, like reference numerals will be used to refer to like elements.

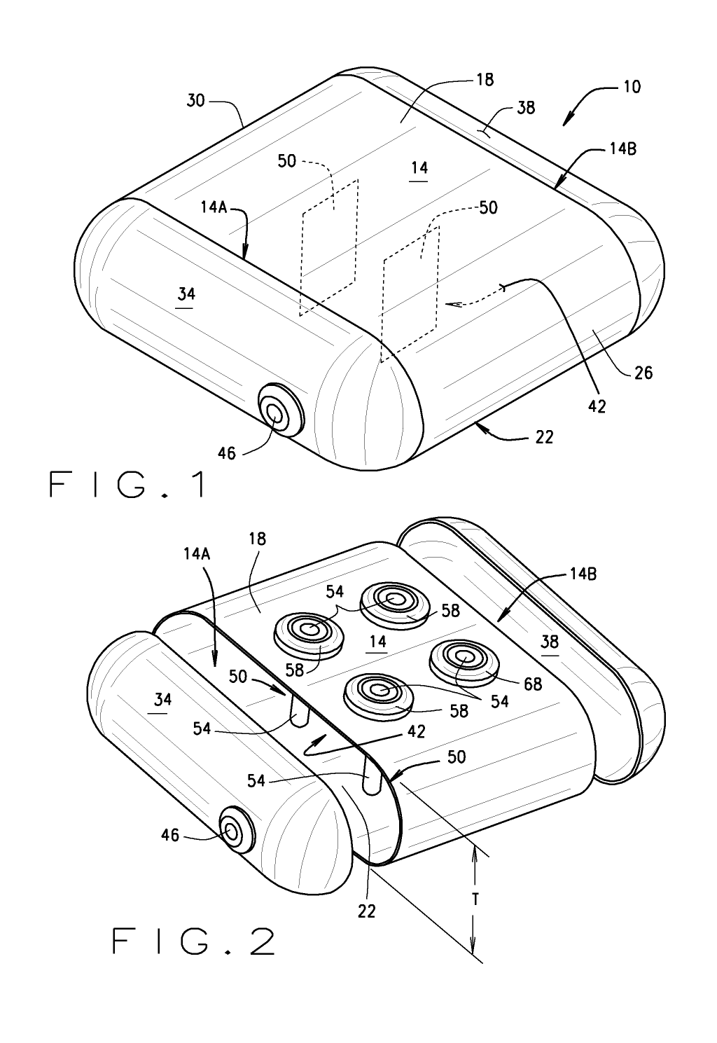

Referring now to FIG. 1, the present disclosure provides a conformal tank 10 that is structured and operable for adsorbent storage and dispensing of compressed gas. In various embodiments, the tank 10 is structured and operable for adsorbent storage and dispensing of compressed natural gas. The tank 10 is further structured to have a conformity index of approximately 0.9 or greater, and can be fabricated to have generally any desired shape. For example, the tank 10 can be fabricated to be square cuboid, a rectangular cuboid, a triangular cuboid, etc. with parallel and/or non-parallel sides.

As used herein, the conformity index or rating will be understood to relate to the amount of volume of a space, compartment or cavity into which the tank 10 is to be disposed the tank 10 will occupy or fill. For example, if the tank 10 is said to have a 0.92 conformity index, it will be understood that the tank 10 occupies or fills approximately 92% of the space, compartment or cavity into which the tank 10 is to be disposed or installed.

The tank 10 generally includes a hollow body 14, a first end cap 34 and a second end cap 38 that are connected and sealed to the body 14. The body 14 includes a substantially flat top wall 18, a substantially flat bottom wall 22, and opposing sidewalls 26 and 30 that form an open-ended cuboid having a first open end 14A and a second open end 14B. The body 14 can be constructed using any suitable fabrication process. For example, in various embodiments, the body 14 can be constructed using a low cost extrusion fabrication process, whereby the body 14 is constructed as a single-piece open-ended duct having any desired cross-sectional shape, e.g., rectangular, square, triangular, oval, oblong, elliptical, etc. or any combination thereof. Additionally, the body 14 can be constructed of any selected material, such as aluminum, steel, composite metal, or any other desired material. For example, in instances where the tank 10 is intended for use as a conformal adsorbent natural gas (ANG) tank, the body 14 can be an extruded aluminum structure having desired thermal qualities that will efficiently transfer and/or enhance the transfer of heat to and from the body 14 during ingress and egress of the natural gas to and from the tank 10. Accordingly, the body 14 can be constructed, via a low cost process, to be light weight and thermally efficient, having any desired thickness required to withstand any particular pressure for which the tank 14 is intended to be used.

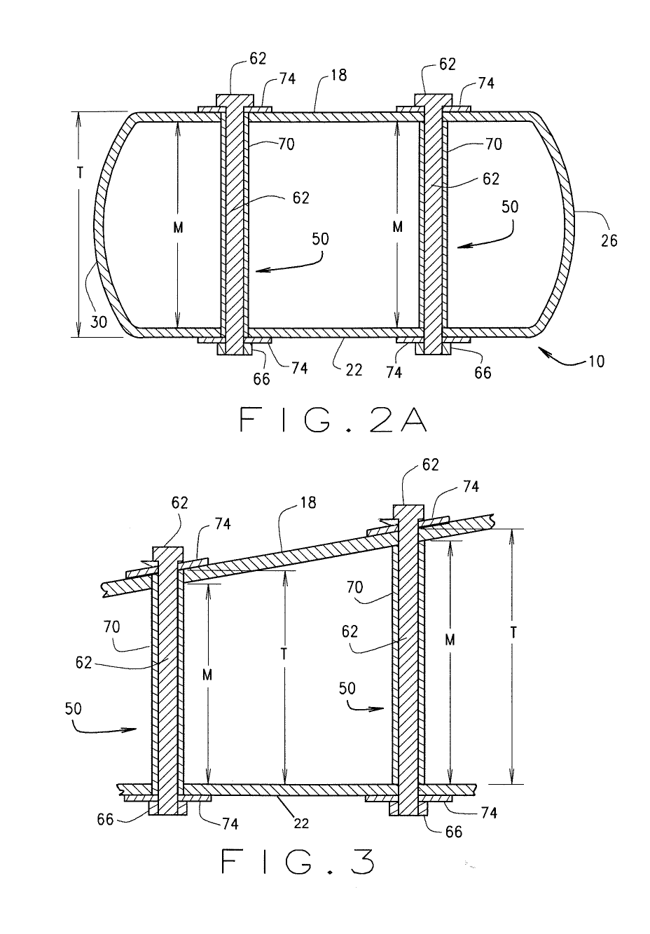

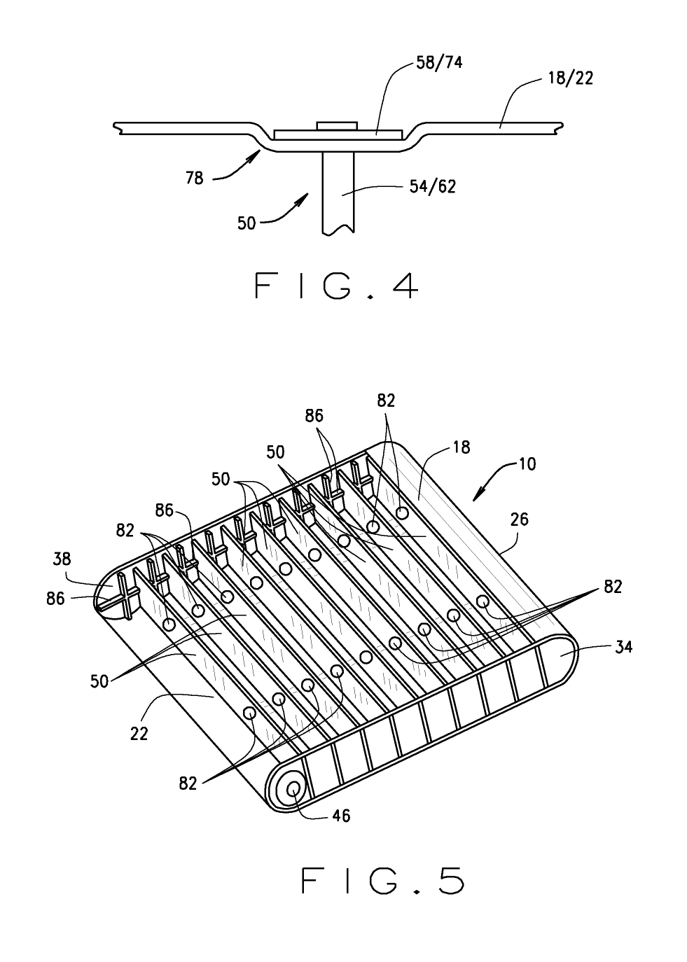

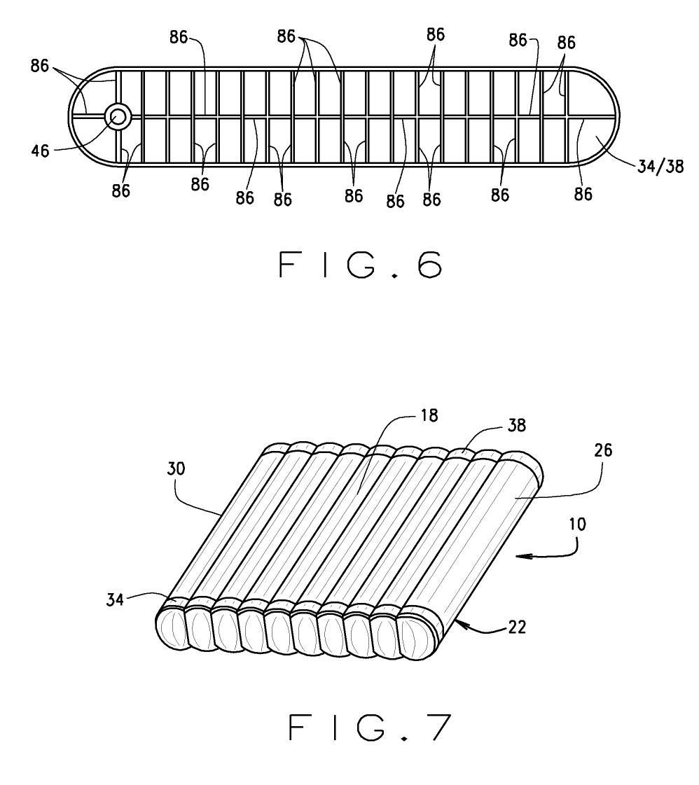

The first end cap 34 is connected to and sealed with the top wall 18, bottom wall 22 and sidewalls 26 and 30 at the first open end 14A of the body 14, and the second end cap 38 connected to and sealed with the top wall 18, bottom wall 22 and sidewalls 26 and 30 at the second open end 14B of the body 14, thereby defining a sealed, air-tight internal storage cavity 42 of the tank 10 in which gas can be removably stored. More specifically, the internal cavity 42 is structured to retain an adsorbent material, e.g., activated carbon or metal organic framework, that will adsorbently retain the gas, e.g., natural gas, within the tank 10. The first and second end caps 34 and 38 can constructed to have a cylindrical shape (as shown in FIGS. 1 and 2), a flat panel shape (as shown in FIGS. 4 and 5), a multiple domed shape (as shown in FIG. 6), or any other desired shape that is suitable for connecting to and sealing with the top wall 18, bottom wall 22 and sidewalls 26 and 30 of the body 14. Additionally, the first and second end caps 34 and 38 can be constructed of any selected material, such as aluminum, steel, composite metal, or any other desired material. For example, in instances where the tank 10 is intended for use as a conformal ANG tank, the first and second end caps 34 and 38 can be constructed of a metal, e.g., aluminum, having desired thermal qualities that will efficiently transfer and/or enhance the transfer of heat to and from the first and second end caps 34 and 38 during ingress and egress of the natural gas to and from the tank 10.

Furthermore, the first and second end caps 34 and 38 can be mated/connected/joined to and sealed with the top wall 18, bottom wall 22 and sidewalls 26 and 30 using any suitable mating/connecting/joining and sealing process or device. For example, in various embodiments, the first and second end caps 34 and 38 can have flanged edges. Similarly, the top wall 18, bottom wall 22 and sidewalls 26 and 30 can also have flanged edges that are mateable, connectable, or joinable with the flanged edges of the first and second end caps 34 and 38 via screws, nuts/bolts, pins, rivets, etc. In such embodiments a seal or gasket can be disposed between the mated, connected or joined flanges. In various other embodiments, the first and second end caps 34 and 38 can be welded or soldered to the top wall 18, bottom wall 22 and sidewalls 26 and 30. In all embodiments, the internal cavity 42 will be filled with the desired adsorbent material prior to mating/connecting/joining at least one of the first and second end caps 34 and 38 to the body 14, and the resulting assembled tank 10 will have been designed to withstand a specified pressure specific to the intended use of the tank 10. For example, in various embodiments, wherein the tank 10 is designated for use as a conformal adsorbent natural gas (ANG) tank, the resulting assembled tank 10 will be able to withstand and sustain internal pressures of 500-1500 psi (lbs/sq. in.). In other embodiments, the resulting assembled tank 10 can be designed to withstand and sustain internal pressures of 100-500 psi, or 1500-3600 psi, or higher.

The tank 10 additionally includes at least one inlet/outlet port 46 disposed in at least one of the first and second end caps 34 and 38 to which and desired flow control valve, pressure meter, etc. can be connected to control the flow of gas into and/or out of the internal cavity 42, monitor the pressure of the gas within the tank 10, etc. The tank 10 further includes a plurality of wall supports 50 connected to the top and bottom walls 18 and 22. The wall supports 50 are structured and operable to prevent deformation of the body 14 and the tank 10 resulting from the internal gas pressure, and/or externally exerted forces on the tank 10. Importantly, the wall supports 50 are structured to allow gas stored in the internal cavity 42 to freely move throughout and within the entire internal cavity 42 of the tank, such that the entire internal cavity 42 can be filled with the gas, and the gas can be extracted or flow from the entire internal cavity 42 via a single inlet/outlet port 46. This facilitates gas flow into and out of the adsorbent material.

Referring now to FIGS. 2, 2A and 3, in various embodiments each wall support 50 comprises a tie rod assembly (hereafter tie rod assembly 50) that extends through the top wall 18, the internal cavity 42 and the bottom wall 22, thereby connecting the top wall 18 to the bottom wall 22 such that the distance between the interiors of the top and bottom walls 18 and 22, i.e, an interior thickness M of the tank 10, is maintained and not altered. That is, the tie rod assemblies 50 prevent outward expansion of the top and bottom walls 18 and 22 caused by the internal gas pressure, and prevent inward encroachment or collapsing of the top and bottom walls 18 and 22 caused by external forces exerted on the top and bottom walls 18 and 22.

As exemplarily illustrated in FIG. 2, in various embodiments, each tie rod assembly 50 can comprise a rod 54 that extends through the top wall 18, the internal cavity 42 and the bottom wall 22 and is welded, or otherwise fixedly connected at opposing ends to the top and bottom walls 18 and 22. In various implementations of such embodiments, each tie rod assembly 50 can further include a pair of force distribution washers 58 that are welded to, or otherwise fixedly connected to the opposing ends of the rod 54 and also welded to, or otherwise fixedly connected to the exterior surface of the respective top and bottom walls 18 and 22. The washers 58 are structured and operable to substantially evenly distribute forces exerted on the top and bottom walls 18 and 22 at the opposing ends of each respective rod 54 over a larger surface area of the respective top and bottom wall 18 and 22.

As exemplarily illustrated in FIGS. 2A and 3, in various embodiments, each tie rod assembly 50 comprises a bolt 62 that extends through the top wall 18, the internal cavity 42 and the bottom wall 22, and a nut 66 that is mateable with a distal end of the bolt 62. In such embodiments, each tie rod assembly 50 additionally includes a sleeve 70 that is disposed over/around the bolt 62. In various implementations of such embodiments the sleeve 70 as a length that is substantially equal to the interior thickness M of the body 14 at the location where the bolt 62 extends through the body 14, whereby the head of bolt 62 and the nut 66 prevent outward expansion of the top and bottom walls 18 and 22 caused by the internal gas pressure, and the sleeve 70 prevents inward encroachment or collapsing of the top and bottom walls 18 and 22 caused by external forces exerted on the top and bottom walls 18 and 22. Alternatively, the sleeve 70 can have a length substantially equal to an exterior thickness T of the body at the location the bolt 62 extends through the body 14.

In various other implementations of such embodiments, each tie rod assembly 50 can further include a pair of force distribution washers 74 that are disposed around the opposing ends of the bolt 62. The washers 74 are structured and operable to substantially evenly distribute forces exerted on the top and bottom walls 18 and 22 at the opposing ends of each respective rod 54 over a larger surface area of the respective top and bottom wall 18 and 22.

Referring now to FIGS. 2, 2A and 3, in various implementations, such as that exemplarily shown in FIG. 3, wherein the plane of at least one of the top and bottom walls 18 and 22 is/are not orthogonal to a longitudinal axis of the one or more of the respective tie rod assemblies 50, i.e., the top and/or bottom wall(s) 18 and/or 22 is/are angled relative to the opposing top or bottom wall 18 or 22, the distribution washer can comprise 2-piece self-aligning washer. In such implementations, the self-aligning washer 74 are structured and operable to substantially evenly distribute forces exerted on the angled top and/or bottom walls 18 and/or 22 at the opposing ends of each respective rod 54 over a larger surface area of the respective angled top and/or bottom wall 18 and/or 22.

Referring now to FIGS. 2, 2A, 3 and 4, in various embodiments, in order to increase the conformity index of the tank 10, the top and/or bottom walls 18 and 22 include a plurality of indentations 78 formed at the locations of the tie rod assemblies 50. The indentations 78 allow the ends of the rods 54 (FIG. 2), the nuts 66 and bolt 62 heads (FIGS. 2A and 3) and the respective force distribution washers 58/74 to be countersunk within the respective top and bottom walls 18 and 22. Particularly, the indentations 78 countersink the ends of the rods 54 (FIG. 2), the nuts 66 and bolt 62 heads (FIGS. 2A and 3) and the respective force distribution washers 58/74 such that the exterior surfaces of the top and bottom walls 18 and 22 can be disposed substantially flush against, or in close proximity to, the walls of the space/compartment/cavity in which the tank 10 is to be disposed, thereby maximizing the conformity index of the tank 10. Hence, the conformity index of the tank 10 can be significantly greater than that of known gas storage tanks, for example the conformity index of tank 10 can be 0.90 or greater.

Referring now to FIG. 5, in various embodiments each wall support 50 comprises a perforated panel (hereafter perforated panel 50) that is disposed within the internal cavity 42 and extends between the top and bottom walls 18 and 22. Each perforated panel 50 is connected along a top edge to the interior surface of the top the wall 18, and connected along a bottom edge to the interior surface of the bottom wall 22, thereby connecting the top wall 18 to the bottom wall 22 such that the interior thickness M of the tank 10, i.e., the distance between the interiors of the top and bottom walls 18 and 22, is maintained and not altered. That is, the perforated panels 50 prevent outward expansion of the top and bottom walls 18 and 22 caused by the internal gas pressure, and prevent inward encroachment or collapsing of the top and bottom walls 18 and 22 caused by external forces exerted on the top and bottom walls 18 and 22. Importantly, each perforated panel 50 comprises a plurality of gas distribution holes 82 that allow the gas stored within the internal cavity 42 to freely move and be distributed throughout and within the entire internal cavity 42 of the tank 10. Since the tank 10 is structured and operable have a single internal cavity, i.e., cavity 42, and to thereby allow the allow the gas to freely move and be distributed throughout and within the entire internal cavity 42, the exterior tubing or pipes of known gas storage tanks (i.e., tubing or pipes connected to the exterior of the tank) that connect a plurality of individual, separate and independent gas storage reservoirs of known gas storage tanks. Hence, the conformity index of the tank 10 can be maximized, e.g., 0.90 or greater, and be significantly greater than that of known gas storage tanks.

Referring now to FIGS. 5 and 6, in order to further increase the conformity index of the tank 10, in various embodiments, at least one of the first and second end caps 34 and 38 are constructed to be substantially flat and panel-like. Hence, the tank 10 can be disposed or installed within a rectangular cuboid space/compartment/cavity and utilizing a substantial percent, e.g., 90% or greater, of the interior volume of the respective space/compartment/cavity. In various implementations of such embodiments, the substantially flat, panel-like first and second end caps 34 and 38 include a plurality of support ridges 86 disposed on at least one of an interior face (as exemplarily illustrated in FIG. 5) and an exterior face (as exemplarily illustrated in FIG. 6) of at least one of the first and second end caps 34 and 38. The support ridges 86 are structured and operable to provide rigidity, strength and structural integrity to the first and/or second end caps 34 and/or 38 to prevent deformation of the first and/or second end caps 34 and/or 38 resulting from the internal gas pressure, and/or externally exerted forces on the tank 10.

Referring now to FIG. 7, although the tank 10 has been described above to have a substantially flat top and bottom walls 18 and 22, it is envisioned that the tank 10 can be constructed as described above with regard to FIGS. 1 through 6, only having a top and bottom walls 34 and 38 that are constructed to have any desire form, shape, contour or texture. For example, in various embodiments, the tank 10 can be constructed as described above with regard to FIGS. 1 through 6, wherein the top and bottom walls 34 and 38 have a rippled or wavy contour, as exemplarily illustrate in FIG. 7. In such embodiments, the tank 10 can further include first and second end caps 34 and 38 that are fabricated to have a shape comprising a plurality of linearly connected domes, as exemplarily illustrated in FIG. 7.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A conformal tank for adsorbent storage of gas, said tank comprising:
a body having a substantially flat top wall, a substantially flat bottom wall and a pair of opposing sidewalls that join the top wall and bottom wall to form an open-ended cuboid having a first open end and an opposing second open end;
a first end cap connected to the top wall, bottom wall and sidewalls at the first open end of the body, and a second end cap connected to the top wall, bottom wall and sidewalls at the second open end of the body, thereby defining an internal cavity of the tank in which gas can be removably stored; and
a plurality of wall supports connected the top and bottom walls to prevent deformation of the tank resulting from the internal gas pressure, the wall supports structured to allow gas to move throughout the entire internal cavity of the tank.

2. The tank of claim 1, wherein the body is constructed as a single-piece hollow duct.

3. The tank of claim 1, wherein at least one of the first end cap and the second end cap is constructed to be substantially flat.

4. The tank of claim 3, wherein the at least one first end cap and second end cap comprises a plurality of support ridges disposed on at least one of an interior face and an exterior face of the at least one first end cap and second end cap.

5. The tank of claim 1, wherein each wall support comprises a tie rod assembly that extends through the top wall, the internal cavity and the bottom wall, thereby connecting the top wall to the bottom wall.

6. The tank of claim 5, wherein each tie rod assembly comprises a sleeved nut and bolt.

7. The tank of claim 1, wherein each wall support comprises a perforated panel disposed within the internal cavity and connecting the top and bottom wall, each perforated panel comprising a plurality of holes that allow the gas to move throughout the entire internal cavity of the tank.

8. A conformal tank for adsorbent storage of gas, said tank comprising:
a single-piece hollow body having a substantially flat top wall, a substantially flat bottom wall and a pair of opposing sidewalls that join the top wall and bottom wall to form an open-ended cuboid having a first open end and an opposing second open end;
a first end cap connected to the top wall, bottom wall and sidewalls at the first open end of the body, and a second end cap connected to the top wall, bottom wall and sidewalls at the second open end of the body, thereby defining an internal cavity of the tank in which gas can be removable stored; and
a plurality of wall supports connected the top and bottom walls to prevent deformation of the tank resulting from the internal gas pressure, the wall supports structured to allow gas to move throughout the entire internal cavity of the tank.

9. The tank of claim 8, wherein at least one of the first end cap and the second end cap is constructed to be substantially flat.

10. The tank of claim 9, wherein the at least one first end cap and second end cap comprises a plurality of support ridges disposed on at least one of an interior face and an exterior face of the at least one first end cap and second end cap.

11. The tank of claim 8, wherein each wall support comprises a tie rod assembly that extends through the top wall, the internal cavity and the bottom wall, thereby connecting the top wall to the bottom wall.

12. The tank of claim 11, wherein each tie rod assembly comprises a sleeved nut and bolt.

13. The tank of claim 8, wherein each wall support comprises a perforated panel disposed within the internal cavity and connecting the top and bottom wall, each perforated panel comprising a plurality of holes that allow the gas to move throughout the entire internal cavity of the tank.

14. A conformal tank for adsorbent storage of gas, said tank comprising:
a single-piece hollow body having a substantially flat top wall, a substantially flat bottom wall and a pair of opposing sidewalls that join the top wall and bottom wall to form an open-ended cuboid having a first open end and an opposing second open end;
a first end cap connected to the top wall, bottom wall and sidewalls at the first open end of the body, and a second end cap connected to the top wall, bottom wall and sidewalls at the second open end of the body, thereby defining an internal cavity of the tank in which gas can be removable stored; and
a plurality of tie rod assembly that extends through the top wall, the internal cavity and the bottom wall, thereby connecting the top wall to the bottom wall to prevent deformation of the tank resulting from the internal gas pressure and to allow gas to move throughout the entire internal cavity of the tank.

15. The tank of claim 14, wherein at least one of the first end cap and the second end cap is constructed to be substantially flat.

16. The tank of claim 15, wherein the at least one first end cap and second end cap comprises a plurality of support ridges disposed on at least one of an interior face and an exterior face of the at least one first end cap and second end cap.

17. The tank of claim 14, wherein each tie rod assembly comprises a sleeved nut and bolt.
